(19) United States
(12) Patent Application Publication
(10) Pub. No.: US 2025/0192906 A1
(43) Pub. Date: Jun. 12, 2025

(54) RADIO DEVICE FOR VEHICLE AND CONTROL METHOD THEREFOR

(71) Applicants: Hyundai Motor Company, Seoul (KR); Kia Corporation, Seoul (KR)

(72) Inventor: Oh Yun Kwon, Hwaseong-si (KR)

(21) Appl. No.: 18/802,652

(22) Filed: Aug. 13, 2024

(30) Foreign Application Priority Data
Dec. 8, 2023 (KR) 10-2023-0177337

(51) Int. Cl. H04H 20/42; H04H 20/12; H04H 20/53

(52) U.S. Cl. CPC H04H 20/42; H04H 20/12; H04H 20/53

(57) ABSTRACT

An embodiment control method for a radio device for a vehicle includes determining whether to scan alternative broadcasts based on a signal quality of a listening broadcast, wherein each of the alternative broadcasts has a same content as the listening broadcast and is a radio broadcast having a frequency or a polarization that is different from the frequency or the polarization of the listening broadcast, scanning the alternative broadcasts, comparing the signal quality of the listening broadcast with signal qualities of the alternative broadcasts to determine to switch the listening broadcast to a selected one of the alternative broadcasts, and in response to a determination to switch the listening broadcast to the selected alternative broadcast, switching the listening broadcast to the selected alternative broadcast.

### CROSS-REFERENCE TO RELATED APPLICATIONS

This application claims the benefit of Korean Patent Application No. 10-2023-0177337, filed on Dec. 8, 2023, which application is hereby incorporated herein by reference in its entirety.

### TECHNICAL FIELD

The present disclosure relates to a radio device for a vehicle and a control method therefor.

### BACKGROUND

The content described in this section simply provides background information for the present disclosure and does not constitute related art.

A vehicle has a radio, digital multimedia broadcasting (DMB), or the like mounted thereon, and occupants in the vehicle may use this to listen to a radio (AM/FM) or a DMB radio broadcast. When a traveling vehicle moves away from a transmitter for a broadcast currently being listened to (hereinafter referred to as a ‘listening broadcast’), a received signal becomes weaker and a broadcasting status worsens, and thus, it is necessary to improve the broadcasting status, for example, through a change into a different frequency of the same broadcast.

In this regard, it is possible to enhance the broadcasting status by scanning the same broadcast as the listening broadcast using an additional tuner in addition to a main tuner and switching between frequencies depending on signal quality of the listening broadcast.

Meanwhile, a polarization of an antenna is an important factor in transmitting and receiving a signal for a radio broadcast. Here, the polarization of the antenna represents a behavior of an electric field radiated by the antenna. For example, when an antenna of the vehicle uses a polarization having a similar angle to a received signal, the signal quality is very high, whereas, when the antenna of the vehicle uses a polarization having an angle substantially perpendicular to the received signal, the signal quality is very low.

### SUMMARY

At least one embodiment of the present disclosure provides a control method for a radio device for a vehicle comprising determining whether to scan alternative broadcasts on the basis of signal quality of a listening broadcast, scanning the alternative broadcasts, comparing the signal quality of the listening broadcast with signal qualities of the alternative broadcasts to determine whether to switch the listening broadcast to an alternative broadcast that is one of the alternative broadcasts, and switching the listening broadcast to the alternative broadcast on the basis of a result of the determination, wherein the alternative broadcast has the same content as the listening broadcast and is a radio broadcast having at least one of a frequency and a polarization different from the listening broadcast.

Another embodiment of the present disclosure provides a radio device for a vehicle comprising a signal processing unit configured to process signals regarding a listening broadcast and alternative broadcasts and a processor configured to switch the listening broadcast to an alternative broadcast that is one of the alternative broadcasts, on the basis of information transferred from the signal processing unit, wherein the alternative broadcast has the same content as the listening broadcast and is a radio broadcast having at least one of a frequency and a polarization different from those of the listening broadcast.

### BRIEF DESCRIPTION OF THE DRAWINGS

FIG. 1 is a block configuration diagram of a radio device for a vehicle according to an embodiment of the present disclosure.

FIG. 2 is a block configuration diagram of a signal processing unit according to an embodiment of the present disclosure.

FIG. 3 is a table showing an example of information on a listening broadcast and an alternative broadcast according to an embodiment of the present disclosure.

FIG. 4 is a flowchart of a control method for a radio device for a vehicle according to an embodiment of the present disclosure.

### DETAILED DESCRIPTION OF ILLUSTRATIVE EMBODIMENTS

A radio device for a vehicle according to an embodiment is configured to switch a frequency and/or a polarization, thereby improving radio signal quality of a vehicle and providing a high-quality service to passengers.

The problems solvable by embodiments of the present invention are not limited to the problems mentioned above, and other problems not mentioned can be clearly understood by those skilled in the art from the description below.

Hereinafter, some exemplary embodiments of the present disclosure will be described in detail with reference to the accompanying drawings. In the following description, like reference numerals preferably designate like elements, although the elements are shown in different drawings. Further, in the following description of some embodiments, a detailed description of known functions and configurations incorporated therein will be omitted for the purpose of clarity and for brevity.

Additionally, various terms such as first, second, A, B, (a), (b), etc. are used solely to differentiate one component from the other but not to imply or suggest the substance, order, or sequence of the components. Throughout this specification, when a part ‘includes’ or ‘comprises’ a component, the part is meant to further include other components, not to exclude thereof unless specifically stated to the contrary. The terms such as ‘unit’, ‘module’, and the like refer to one or more units for processing at least one function or operation, which may be implemented by hardware, software, or a combination thereof.

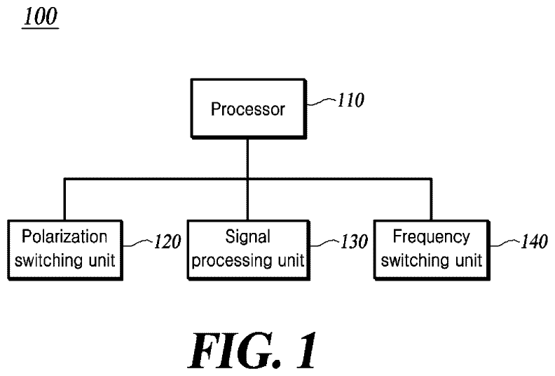

FIG. 1 is a block configuration diagram of a radio device for a vehicle according to an embodiment of the present disclosure.

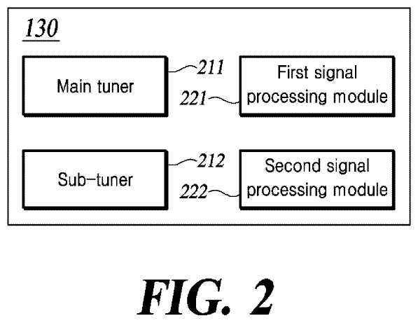

FIG. 2 is a block configuration diagram of a signal processing unit according to an embodiment of the present disclosure.

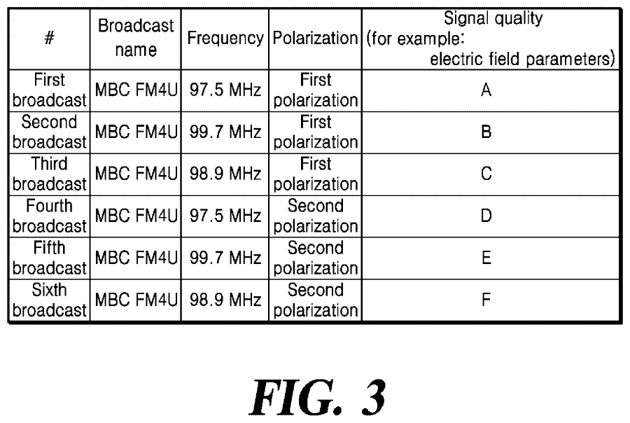

FIG. 3 is a table showing an example of information on a listening broadcast and an alternative broadcast according to an embodiment of the present disclosure.

Referring to FIGS. 1 and 2, a radio device 100 for a vehicle according to an embodiment of the present disclosure includes a processor 110, a polarization switching unit 120, a signal processing unit 130, and a frequency switching unit 140.

The signal processing unit 130 may include a main tuner 211, a sub-tuner 212, a first signal processing module 221, and a second signal processing module 222.

The processor 110 may receive information on a broadcast currently being listened to (hereinafter referred to as a ‘listening broadcast’) and alternative broadcasts from the signal processing unit 130. Here, the alternative broadcast refers to a radio broadcast that has the same content as the listening broadcast and has a different frequency and/or polarization from the listening broadcast. For example, as illustrated in FIG. 3, when the listening broadcast is a first broadcast, the alternative broadcasts refer to second to sixth broadcasts having the same content as the first broadcast that is the listening broadcast, that is, having the same broadcast name as MBC FM4U and having a different frequency and/or polarization from the first broadcast.

The processor 110 determines whether or not the alternative broadcasts are to be scanned on the basis of a signal (information) transferred from the signal processing unit 130. The processor 110 determines whether or not the alternative broadcasts are to be scanned on the basis of the signal quality of the listening broadcast. The processor 110 determines whether or not the alternative broadcasts are to be scanned on the basis of whether a signal strength of the listening broadcast is equal to or higher than a reference strength. When the signal strength of the listening broadcast is higher than the reference strength, the processor 110 may control the signal processing unit 130 so that the signal processing unit 130 does not scan the alternative broadcasts because the signal quality of the listening broadcast is sufficiently high. When the signal strength of the listening broadcast is less than the reference strength, the processor 110 may control the signal processing unit 130 so that the signal processing unit 130 scans the alternative broadcasts in order to find a broadcast with higher signal quality.

The signal processing unit 130 may be configured to receive and process signals regarding the listening broadcast and the alternative broadcast. Specifically, the main tuner 211 and the first signal processing module 221 of the signal processing unit 130 may be configured to receive and process the signal regarding the listening broadcasts, and the sub-tuner 212 and the second signal processing module 222 may be configured to receive and process the signal regarding the alternative broadcast.

The signal processing unit 130 can scan alternative broadcasts. Specifically, when the processor 110 determines that the signal strength of the listening broadcast is equal to or lower than the reference strength, the signal processing unit 130 may scan the alternative broadcasts. The signal processing unit 130 may select the alternative broadcast using the sub-tuner 212 and the second signal processing module 222 and collect information on the selected alternative broadcast.

The signal processing unit 130 may select the alternative broadcast on the basis of signal patterns of the plurality of detected broadcasts and the listening broadcast. The signal processing unit 130 may select, as the alternative broadcast, a broadcast with a correlation (DTAC; Dual Tuner Acoustic Correlation) equal to or higher than a threshold from among the plurality of detected broadcasts. As described above, here, the alternative broadcast refers to a radio broadcast that has the same content as the listening broadcast, has the same broadcast name, and has a different frequency and/or polarization. The signal processing unit 130 determines the correlation between the plurality of detected broadcasts and the listening broadcast on the basis of information on radio broadcasts stored in memory (not illustrated) and/or a server (not illustrated) and a signal received through the sub-tuner 212.

Meanwhile, although the signal processing unit 130 may select the alternative broadcast on the basis of the received signal as described above, the processor 110 may select the alternative broadcast on the basis of a signal received by the signal processing unit 130.

The signal processing unit 130 may receive a signal of the selected alternative broadcast and collect information on frequency, polarization, and/or signal quality. The signal processing unit 130 may process the signal and transfer the collected information to the processor 110.

The processor 110 may determine the signal quality of the listening broadcast with signal qualities of the alternative broadcast to determine whether to switch the listening broadcast to an alternative broadcast that is one of the alternative broadcasts and may switch the listening broadcast to the alternative broadcast by switching the frequency and/or polarization to a value corresponding to the alternative broadcast using the polarization switching unit 120 and/or the frequency switching unit 140 when the signal quality of the alternative broadcast is higher than the signal quality of the listening broadcast.

Specifically, referring back to FIG. 3, assuming that the first broadcast corresponds to the listening broadcast and the second to sixth broadcasts are alternative broadcasts, the processor 110 may compare the signal quality of the first broadcast, which is the listening broadcast, with the signal qualities of the second to sixth broadcasts, which are the alternative broadcasts on the basis of the information transferred from the signal processing unit 130. In this case, the signal quality may be a signal strength, or electric field parameters according to an electric field condition, and the electric field parameters are shown as an example in FIG. 3. When an electric field parameter A is superior to B, C, D, E, and F, the processor 110 may determine that the signal quality of the listening broadcast is higher than that of the alternative broadcast and may determine not to switch the frequency and polarization. On the other hand, when the electric field parameter B is superior to A, the second broadcast corresponds to the alternative broadcast, and the processor 110 determines that it is necessary to switch the first broadcast, which is the listening broadcast, to the second broadcast, which is the alternative broadcast. Here, since the second broadcast has the same polarization as the first broadcast and a different frequency from the first broadcast, the processor 110 may switch the first broadcast to the second broadcast by switching the frequency using the frequency switching unit 140. As another example, when the electric field parameter D is superior to A, the fourth broadcast corresponds to the alternative broadcast, and the processor 110 determines that it is necessary to switch the first broadcast, which is the listening broadcast, to the fourth broadcast, which is the alternative broadcast. Here, since the fourth broadcast has the same frequency as the first broadcast and a different polarization from the first broadcast, the processor 110 can switch the first broadcast to the fourth broadcast by switching the polarization using the polarization switching unit 120. As another example, when the electric field parameter E is superior to A, the fifth broadcast corresponds to the alternative broadcast, and the processor 110 determines that it is necessary to switch the first broadcast, which is the listening broadcast, to the fifth broadcast, which is the alternative broadcast. Here, since the fifth broadcast is different from the first broadcast in both the frequency and the polarization, the processor 110 may switch the first broadcast to the fifth broadcast by switching the frequency and the polarization using the frequency switching unit 140 and the polarization switching unit 120.

Thus, the radio device 100 according to embodiments of the present disclosure is configured to be able to switch the listening broadcast to an alternative broadcast with higher signal quality than the listening broadcast when the signal quality of the listening broadcast deteriorates, and it can further improve the signal quality and provide a high-quality service to occupants in the vehicle by scanning alternative broadcasts with a different frequency and a different polarization from the listening broadcast.

The polarization switching unit 120 may be configured to generate and use a plurality of polarizations. The polarization switching unit 120 may generate a first polarization and a second polarization. A difference in polarization angle between the first polarization and the second polarization may be 90 degrees. The signal processing unit 130 can process signals regarding alternative broadcasts based on the plurality of polarizations generated by the polarization switching unit 120.

The polarization switching unit 120 may be configured to include a plurality of polarization antennas. For example, when the polarization switching unit 120 includes two polarization antennas, one of the polarization antennas may use a polarization of −45 degrees, and the other may use a polarization of +45 degrees. Further, the polarization switching unit 120 may include one antenna and may be configured of a PIN diode and the like to generate the plurality of polarization waves.

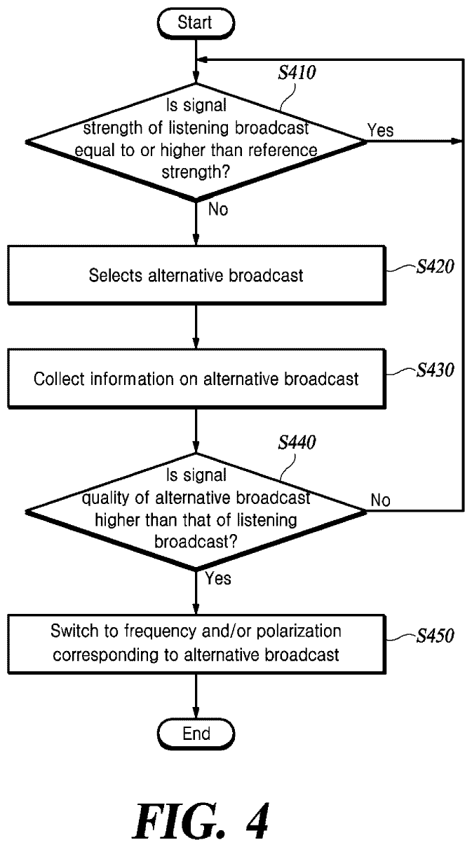

FIG. 4 is a flowchart of a control method for a radio device for a vehicle according to an embodiment of the present disclosure.

The processor 110 determines whether or not the alternative broadcasts are to be scanned on the basis of the signal quality of the listening broadcast. The processor 110 determines whether or not the alternative broadcasts are to be scanned on the basis of whether the signal strength of the listening broadcast is equal to or higher than the reference strength (S410).

When the signal strength of the listening broadcast is less than the reference strength, the signal processing unit 130 scans the alternative broadcasts. The signal processing unit 130 selects the alternative broadcast (S420). The signal processing unit 130 selects the alternative broadcast on the basis of the signal patterns of the plurality of detected broadcasts and the listening broadcast. The signal processing unit 130 may select the broadcast with a correlation (DTAC) with the plurality of detected broadcasts greater than the threshold as the alternative broadcast. The signal processing unit 130 collects information on the alternative broadcast (S430). The signal processing unit 130 may receive a signal of the selected alternative broadcast and collect information on frequency, polarization, and/or signal quality.

The processor 110 determines whether or not the signal quality of the alternative broadcast is higher than that of the listening broadcast (S440). The processor 110 compares the signal quality of the listening broadcast with the signal quality of the alternative broadcast to determine whether to switch the listening broadcast to the alternative broadcast that is any one of the alternative broadcasts.

When the processor 110 determines that the signal quality of the alternative broadcast is higher than that of the listening broadcast, the processor 110 determines that it is necessary to switch the frequency and/or polarization to a value corresponding to the alternative broadcast and switches the frequency and/or polarization to the value corresponding to alternative broadcast (S450).

According to an embodiment, there is an effect that the radio device for a vehicle is configured to switch a frequency and/or polarization, thereby improving radio signal quality of a vehicle and providing a high-quality service to passengers.

Although it is described that the processes are sequentially executed in the flowchart of embodiments of the present disclosure, this is merely illustrative of the technical idea of some embodiments of the present disclosure. In other words, since an ordinary skilled person in the art to which the embodiments of the present disclosure pertain may make various modifications and changes by changing the processes described in the flowchart/timing diagram or performing one or more of the processes in parallel without departing from the essential characteristics of the embodiments of the present disclosure, the flowchart/timing diagram is not limited to a time-series order.

Various implementations of the systems and techniques described herein may be realized by digital electronic circuits, integrated circuits, field programmable gate arrays (FPGAs), application specific integrated circuits (ASICs), computer hardware, firmware, software, and/or a combination thereof. These various implementations may include an implementation by one or more computer programs executable on a programmable system. The programmable system includes at least one programmable processor (which may be a special purpose processor or a general-purpose processor) coupled to a storage system, at least one input device, and at least one output device to receive and transmit data and instructions therefrom and thereto. Computer programs (also known as programs, software, software applications, or codes) contain instructions for the programmable processor and are stored in a “computer-readable recording medium”.

The computer-readable recording medium includes all types of recording devices in which data readable by a computer system is stored. The computer-readable recording medium may include non-volatile or non-transitory mediums such as ROM, RAM, CD-ROM, magnetic tape, floppy disk, memory card, hard disk, optical disk, and storage device, and may further include a temporary medium such as a data transmission medium. In addition, the computer-readable recording medium may be distributed in a network-connected computer system, and computer-readable codes may be stored and executed in a distributed manner.

Various implementations of systems and techniques described herein may be implemented by a programmable computer. Here, the computer includes a programmable processor, a data storage system (including a volatile memory, a nonvolatile memory, or another type of storage system or a combination thereof), and at least one communication interface. For example, a programmable computer may be one of a server, a network device, a set-top box, a built-in device, a computer expansion module, a personal computer, a laptop, a personal data assistant (PDA), a cloud computing system, and a mobile device.

Although exemplary embodiments of the present disclosure have been described for illustrative purposes, those skilled in the art will appreciate that various modifications, additions, and substitutions are possible, without departing from the idea and scope of the claimed invention. Therefore, exemplary embodiments of the present disclosure have been described for the sake of brevity and clarity. The scope of the technical idea of the present embodiments is not limited by the illustrations. Accordingly, one of ordinary skill would understand the scope of the claimed invention is not to be limited by the above explicitly described embodiments but by the claims and equivalents thereof.

What is claimed is:

1. A control method for a radio device for a vehicle, the control method comprising:
determining whether to scan alternative broadcasts based on a signal quality of a listening broadcast, wherein each of the alternative broadcasts has the same content as the listening broadcast and is a radio broadcast having a frequency or a polarization that is different from the frequency or the polarization of the listening broadcast;
scanning the alternative broadcasts;
comparing the signal quality of the listening broadcast with signal qualities of the alternative broadcasts to determine to switch the listening broadcast to a selected one of the alternative broadcasts; and
in response to a determination to switch the listening broadcast to the selected alternative broadcast, switching the listening broadcast to the selected alternative broadcast.

2. The control method of claim 1, wherein determining whether to scan the alternative broadcasts is based on whether a signal strength of the listening broadcast is equal to or higher than a reference strength.

3. The control method of claim 1, wherein scanning the alternative broadcasts comprises:
selecting the alternative broadcasts; and
collecting information on the alternative broadcasts.

4. The control method of claim 3, wherein the alternative broadcasts are selected from among a plurality of detected broadcasts based on signal patterns of the plurality of detected broadcasts and the listening broadcast.

5. The control method of claim 3, wherein the information on the alternative broadcasts comprises the frequency, the polarization, and the signal quality of each of the alternative broadcasts.

6. The control method of claim 1, wherein switching the listening broadcast to the selected alternative broadcast comprises switching the frequency and the polarization to the frequency and the polarization corresponding to the selected alternative broadcast.

7. The control method of claim 1, wherein determining to switch the listening broadcast to the selected alternative broadcast comprises determining that the signal quality of the selected alternative broadcast is higher than the signal quality of the listening broadcast.

8. A radio device for a vehicle, the radio device comprising:
a signal processing device configured to process signals regarding a listening broadcast and alternative broadcasts, wherein each of the alternative broadcast has a same content as the listening broadcast and is a radio broadcast having a frequency or a polarization that is different from the frequency or the polarization of the listening broadcast; and
a processor configured to switch the listening broadcast to a selected alternative broadcast from among the alternative broadcasts based on information transferred from the signal processing device.

9. The radio device of claim 8, wherein the processor is configured to switch the listening broadcast to the selected alternative broadcast using a polarization switching device or a frequency switching device.

10. The radio device of claim 9, wherein the polarization switching device comprises a plurality of polarization antennas.

11. The radio device of claim 9, wherein the polarization switching device comprises a single antenna and is configured of a PIN diode.

12. The radio device of claim 8, wherein the signal processing device comprises a main tuner, a sub-tuner, a first signal processing circuit, and a second signal processing circuit.

13. A control method for a radio device for a vehicle, the control method comprising:
determining that a signal strength of a listening broadcast is less than a reference strength;
in response to determining that the signal strength of the listening broadcast is less than the reference strength, scanning alternative broadcasts, wherein each of the alternative broadcasts has the same content as the listening broadcast and is a radio broadcast having a frequency or a polarization that is different from the frequency or the polarization of the listening broadcast;
collecting information on the alternative broadcasts, wherein the information on the alternative broadcasts comprises the frequency, the polarization, and a signal quality of each of the alternative broadcasts;
comparing a signal quality of the listening broadcast with the signal quality of each of the alternative broadcasts; and
determining whether to switch the listening broadcast to a selected alternative broadcast from among the alternative broadcasts based on the comparing determining that the signal quality of the selected alternative broadcast is higher than the signal quality of the listening broadcast.

14. The control method of claim 13, in response to a determination to switch the listening broadcast to the selected alternative broadcast, switching the listening broadcast to the selected alternative broadcast.

15. The control method of claim 13, wherein scanning the alternative broadcasts comprises selecting the alternative broadcasts from among a plurality of detected broadcasts.

16. The control method of claim 15, wherein the alternative broadcasts are selected from among the plurality of detected broadcasts based on signal patterns of the plurality of detected broadcasts and the listening broadcast.

17. The control method of claim 13, wherein switching the listening broadcast to the selected alternative broadcast comprises switching the frequency and the polarization to the frequency and the polarization corresponding to the selected alternative broadcast.

18. The control method of claim 13, switching the listening broadcast to the selected alternative broadcast is performed by switching a frequency.

19. The control method of claim 13, switching the listening broadcast to the selected alternative broadcast is performed by switching a polarization.

20. The control method of claim 19, wherein switching the polarization is performed using a plurality of polarization antennas and using a single antenna and configuring a PIN diode.
